(19) United States
(12) Patent Application Publication
(10) Pub. No.: US 2011/0213812 A1
(43) Pub. Date: Sep. 1, 2011

(54) DEVICE AND A METHOD FOR PROVIDING METADATA TO BE STORED

(75) Inventor: Gilein De Nijs, Eindhoven (NL)

(73) Assignee: KONINKLIJKE PHILIPS ELECTRONICS N.V., EINDHOVEN (NL)

(21) Appl. No.: 12/673,035

(22) PCT Filed: Aug. 8, 2008
(86) PCT No.: PCT/IB08/53192

§ 371 Date: Feb. 11, 2010

(30) Foreign Application Priority Data
Aug. 17, 2007 (EP) 07114545.2

(51) Int. Cl. G06F 17/30

(52) U.S. Cl. 707/822; 707/E17.01

(57) ABSTRACT

Disclosed are methods and devices for providing metadata (120) to be stored. Periods may be indicated by a point at which the metadata becomes valid (150) and a second point at which the metadata becomes invalid (160). The metadata may be encoded, by an encoder (500) in a file format compatible with or based upon an ISO Base Media File format (510). Similarly, the indication of the point at which the metadata becomes valid and the indication of the second point at which the metadata becomes invalid may also be encoded in the file format compatible with or based upon the ISO Base Media File format. This may be performed by a transmitter (400) or by a receiver (470). A plurality of metadata items may also be stored in the file format in a single location providing efficient storage and retrieval.

### FIELD OF THE INVENTION

The invention relates to a method for providing metadata to be stored.

The invention further relates to a transmitter and method of transmitting metadata to be stored.

The invention further relates to a receiver and method of receiving metadata to be stored.

The invention further relates to a renderer and method of rendering metadata stored.

The invention further relates to a signal for use in providing metadata to be stored.

The invention further relates to a system for providing metadata to be stored.

The invention further relates to a program element.

The invention further relates to a computer-readable medium.

### BACKGROUND OF THE INVENTION

Within the DVB consortium a common file format, to be used for interchange of content between all DVB compatible devices, has been designed. This DVB file format is based on the ISO Base File Format, which is standardized in ISO/IEC 14496-12. An amendment to this standard proposes the timed metadata tracks and is identified as ISO/IEC 14496-12:2005/Amd 1:2007. However, there remain limitations to this standard even when amended. It would be advantageous to extend the design of the common file format. It is not possible currently to provide a way for storing descriptive metadata adhering to existing DVB metadata schemas in a DVB File. Furthermore, it is not possible to link parts of the metadata to parts of the content, the content being audio, video, graphics, text etc. There is no method to provide a flexible and hierarchical linking structure even though this would allow some parts of the metadata to be valid for large parts of the content, while other parts may be valid for shorter periods during those large parts, i.e. enabling overlapping validity. Also, in the prior art on record it is not possible to convey that individual parts of the metadata or metadata items may be valid multiple times, or have overlapping points for starting or stopping validity.

The inventors recognizing this problem in the prior art devised the present invention.

### BRIEF SUMMARY OF THE INVENTION

It would be advantageous to achieve a more powerful manner to convey complex metadata structures in a way adhering where possible to existing metadata schemas.

Accordingly, there is provided, in a first aspect of the present invention, a method for providing metadata to be stored, the method comprising obtaining the metadata, obtaining an indication of a point at which the metadata becomes valid, obtaining an indication of a second point at which the metadata becomes invalid, encoding the metadata obtained in a file format compatible with or based upon an ISO Base Media File format, encoding the indication of the point at which the metadata becomes valid in the file format compatible with or based upon the ISO Base Media File format and encoding the indication of the second point at which the metadata becomes invalid in the file format compatible with or based upon the ISO Base Media File format.

According to a second aspect of the invention, there is provided, a transmitter for transmitting metadata to be stored, the transmitter comprising a first input for obtaining the metadata, a second input for obtaining an indication of a point at which the metadata becomes valid, a third input for obtaining an indication of a second point at which the metadata becomes invalid and a transmitting unit, communicatively coupled to the first input, the second input and the third input, for transmitting the metadata, the indication of the point at which the metadata becomes valid, and the indication of the second point at which the metadata becomes invalid, the transmission being in a form suitable for encoding in a file format compatible with or based upon an ISO Base Media File format.

According to a third aspect of the invention, there is provided, a method of transmitting metadata to be stored, the method comprising obtaining the metadata, obtaining an indication of a point at which the metadata becomes valid, obtaining an indication of a second point at which the metadata becomes invalid and transmitting the metadata, the indication of the point at which the metadata becomes valid, and the indication of the second point at which the metadata becomes invalid in a form suitable for encoding in a file format compatible with or based upon an ISO Base Media File format.

According to a fourth aspect of the invention, there is provided, a receiver for receiving metadata to be stored, the receiver comprising a first input for receiving the metadata, a second input for receiving an indication of a point at which the metadata becomes valid, a third input for receiving an indication of a second point at which the metadata becomes invalid, an encoder, communicatively coupled to the first input, the second input and the third input, for encoding the metadata obtained in a file format compatible with or based upon an ISO Base Media File format, for encoding the indication of the point at which the metadata becomes valid in the file format compatible with or based upon the ISO Base Media File format and for encoding the indication of the second point at which the metadata becomes invalid in the file format compatible with or based upon the ISO Base Media File format.

According to a fifth aspect of the invention, there is provided, a method of receiving metadata to be stored, the method comprising receiving the metadata, receiving an indication of a point at which the metadata becomes valid, receiving an indication of a second point at which the metadata becomes invalid, encoding the metadata obtained in a file format compatible with or based upon an ISO Base Media File format, encoding the indication of the point at which the metadata becomes valid in the file format compatible with or based upon the ISO Base Media File format and encoding the indication of the second point at which the metadata becomes invalid in the file format compatible with or based upon the ISO Base Media File format.

According to a sixth aspect of the invention, there is provided, a method of rendering metadata provided in the file format compatible with or based upon the ISO Base Media File format of the fifth aspect or the third aspect, the third aspect further comprising encoding the metadata obtained in the file format compatible with or based upon the ISO Base Media File format, encoding the indication of the point at which the metadata becomes valid in the file format compatible with or based upon the ISO Base Media File format, encoding the indication of the second point at which the metadata becomes invalid in the file format compatible with or based upon the ISO Base Media File format and transmitting the file format compatible with or based upon the ISO Base Media File format. The method comprising decoding the metadata encoded in the file format compatible with or based upon the ISO Base Media File format, decoding the indication of the point at which the metadata becomes valid in the file format compatible with or based upon the ISO Base Media File format and decoding the indication of the second point at which the metadata becomes invalid in the file format compatible with or based upon the ISO Base Media File format and rendering the metadata in accordance with the indication of the point at which the metadata becomes valid and the indication of the second point at which the metadata becomes invalid.

According to a seventh aspect of the invention, there is provided, a rendering device for rendering the file format compatible with or based upon the ISO Base Media File format, the rendering device comprising a decoder for decoding the metadata encoded in the file format compatible with or based upon the ISO Base Media File format, for decoding the indication of the point at which the metadata becomes valid in the file format compatible with or based upon the ISO Base Media File format and for decoding the indication of the second point at which the metadata becomes invalid in the file format compatible with or based upon the ISO Base Media File format and a rendering unit for rendering the metadata in accordance with the indication of the point at which the metadata becomes valid and the indication of the second point at which the metadata becomes invalid.

According to a eighth aspect of the invention, there is provided, a signal for use in providing metadata to be stored, the signal comprising the metadata, an indication of a point at which the metadata becomes valid, an indication of a second point at which the metadata becomes invalid, the signal being suitable for encoding the metadata in a file format compatible with or based upon an ISO Base Media File format, encoding the indication of the point at which the metadata becomes valid in the file format compatible with or based upon the ISO Base Media File format and encoding the indication of the second point at which the metadata becomes invalid in the file format compatible with or based upon the ISO Base Media File format.

According to a ninth aspect of the invention, there is provided, a signal for use in providing metadata to be stored, the signal comprising the metadata encoded in a file format compatible with or based upon an ISO Base Media File format form, an indication of a point at which the metadata becomes valid encoded in the file format compatible with or based upon the ISO Base Media File format form and an indication of a second point at which the metadata becomes invalid encoded in the file format compatible with or based upon the ISO Base Media File format form.

According to a tenth aspect of the invention, there is provided, a system for providing metadata to be stored, the system comprising the transmitter according to the second aspect of the invention, the signal according to the eighth aspect of the invention and the receiver according to the fourth aspect of the invention.

According to an eleventh aspect of the invention, there is provided, a system for providing metadata to be stored, the system comprising the transmitter according to the second aspect of the invention wherein the transmitting unit comprises an encoder, communicatively coupled to the first input, the second input and the third input, and for encoding the metadata obtained in the file format compatible with or based upon the ISO Base Media File format, for encoding the indication of the point at which the metadata becomes valid in the file format compatible with or based upon the ISO Base Media File format and for encoding the indication of the second point at which the metadata becomes invalid in the file format compatible with or based upon the ISO Base Media File format and wherein the transmitting unit being configured for transmitting the file format compatible with or based upon the ISO Base Media File format, the signal according to the ninth aspect of the invention and the rendering device according to the seventh aspect of the invention.

According to a twelfth aspect of the invention, there is provided, a program element directly loadable into the memory of a programmable device, comprising software code portions for performing, when said program element is run on the device, the method of obtaining metadata, obtaining an indication of a point at which the metadata becomes valid, obtaining an indication of a second point at which the metadata becomes invalid, encoding the metadata obtained in a file format compatible with or based upon an ISO Base Media File format, encoding the indication of the point at which the metadata becomes valid in the file format compatible with or based upon the ISO Base Media File format and encoding the indication of the second point at which the metadata becomes invalid in the file format compatible with or based upon the ISO Base Media File format.

According to a thirteenth aspect of the invention, there is provided, a computer-readable medium directly loadable into the memory of a programmable device, comprising software code portions for performing, when said code portions are run on the device, the method of obtaining metadata, obtaining an indication of a point at which the metadata becomes valid, obtaining an indication of a second point at which the metadata becomes invalid, encoding the metadata obtained in a file format compatible with or based upon an ISO Base Media File format, encoding the indication of the point at which the metadata becomes valid in the file format compatible with or based upon the ISO Base Media File format and encoding the indication of the second point at which the metadata becomes invalid in the file format compatible with or based upon the ISO Base Media File format.

By providing an indication of a point at which metadata becomes invalid and ensuring that this information is used during the encoding in a the file format compatible with or based upon the ISO Base File Format it becomes possible to determined exact periods of validity without any assumptions having to be made.

In one embodiment the metadata may comprise a plurality of metadata items and for each metadata item an indication of a third point at which each metadata item becomes valid may be obtained along with an indication of a fourth point at which each metadata becomes invalid. Encoding the indication of the third point and the indication of the fourth point may be performed and they may be encoded in a single box or a single sample in the file format compatible with or based upon the ISO Base Media File format. Storing the metadata separately from the validity information is advantageous because it provides a single location for metadata storage allowing efficient storage and retrieval when all metadata relevant to a file is requested.

In a further embodiment for at least one metadata item of the plurality of metadata items an identifier capable of identifying or being resolved to identify the at least one metadata item may be obtained. The identifier may be encoded in the single box or the single sample in the file format compatible with or based upon the ISO Base Media File format. This provides the advantage that a complex metadata structure may be created whilst retaining a single location for metadata storage allowing efficient storage and retrieval when all metadata relevant to a file is requested.

In another embodiment the identifier may be a Uniform Resource Indicator. This is a widely accepted method of identifying items and is broadly compatible with many devices.

In yet another embodiment for at least two metadata items of the plurality of metadata items an indication of a type of the at least two metadata items may be obtained. A group of metadata items may be formed according to the indication of the type of the at least two metadata items and encoding may be performed in a grouped manner for each identifier of the group of metadata items in the single box or the single sample in the file format compatible with or based upon the ISO Base Media File format. The encoding in the grouped manner may also comprise encoding the indication of the third point and/or the indication of the fourth point. This allows efficient processing and reduces the amount of information required in a transmission stream.

In an embodiment for at least one metadata item of the plurality of metadata items an item identifier may be obtained. The item identifier may be encoded for at least one metadata item in the single box or the single sample in the file format compatible with or based upon the ISO Base Media File format. This provides an alternative solution for situations where no URI is available.

In another embodiment for at least one metadata item of the plurality of metadata items a hierarchy indication may be obtained. The hierarchy indication for the at least one metadata item may be encoded in the single box or the single sample in the file format compatible with or based upon the ISO Base Media File format. This allows the plurality of metadata items to be related to each other in an even more complex hierarchical relationship and yet provides an efficient metadata storage mechanism.

In another embodiment for a fifth point a list may be formed of all valid metadata items based upon the indication of the third point at which the metadata items become valid and the indication of a fourth point at which the metadata items become invalid. The list may be encoded in the single box or the single sample in the file format compatible with or based upon the ISO Base Media File format. Such a feature provides synchronization points from which point the complete current metadata validity status may be inferred and is advantageous for use in track play modes.

In a further embodiment the list may be formed in a repeatable manner for a plurality of points. The encoding of the list in the file format compatible with or based upon the ISO Base Media File format may be performed in a repeatable manner to provide a plurality of synchronization points from which the validity of each metadata item may be inferred. The repeated forming and encoding of the list provides a larger number of locations to jump to in trick play modes.

In a further embodiment a device according to the invention, for example, a receiver or a rendered, may be realized as at least one of the group consisting of a Set-Top-Box device, a digital video recording device, a network-enabled device, a conditional access system, a portable audio player, a portable video player, a mobile phone, a DVD player, a CD player, a hard disk based media player, an Internet radio device, a computer, a television, a public entertainment device and an MP3 player. However, these applications are only exemplary.

The data processing required according to the invention can be realized by a computer program, that is to say by software, or by using one or more special electronic optimization circuits, that is to say in hardware, or in hybrid form, that is to say by means of software components and hardware components.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a complex metadata structure incompatible with prior art metadata transmission methods.

FIG. 2 illustrates a metadata structure using a single timed metadata track.

FIG. 3 illustrates a metadata structure using multiple timed metadata tracks.

FIG. 4 illustrates an embodiment of a system wherein a transmitter is configured to transmit metadata and metadata validity information to a receiver.

FIG. 5 illustrates an embodiment of a system wherein a transmitter is configured to encode metadata and metadata validity information in an ISO Base File Format or equivalent and transmit it to a receiver.

FIG. 6 illustrates an embodiment of a system wherein a transmitter is configured to transmit a plurality of metadata items and validity information for each metadata item to a receiver.

FIG. 7 illustrates an embodiment of a system wherein a receiver is configured to receive metadata and metadata validity information and to encode, and decode, metadata and metadata validity information in, and from, an ISO Base File Format or equivalent.

FIG. 8 illustrates an embodiment of a system wherein a rendering device is configured to receive metadata and metadata validity information, to encode and decode the ISO Base File Format or equivalent and to render the metadata.

FIG. 9 illustrates an embodiment of a system wherein a rendering device is configured to receive metadata and metadata validity information in an ISO Base File Format or equivalent and to render the metadata.

FIG. 10 illustrates a flowchart wherein metadata is received along with metadata validity information, the metadata and validity information is encoded and stored in an ISO Base File Format or equivalent.

The Figures are schematically drawn and not true to scale, and the identical reference numerals in different Figures refer to corresponding elements. It will be clear for those skilled in the art, that alternative but equivalent embodiments of the invention are possible without deviating from the true inventive concept, and that the scope of the invention will be limited by the claims only.

### DETAILED DESCRIPTION OF THE INVENTION

Within the DVB consortium a common file format, to be used for interchange of content between all DVB compatible devices, has been designed. This DVB file format is based on the ISO Base File Format, which is standardized in ISO/IEC 14496-12. An amendment to this standard proposes the timed metadata tracks and is identified as ISO/IEC 14496-12:2005/Amd 1:2007. However, there remain limitations to this standard even when amended. It would be advantageous to extend the design of the common file format. For example, by providing a way for storing descriptive metadata adhering to existing DVB metadata schemas in a DVB file may be defined. Furthermore, it could be made possible to link parts of the metadata to parts of the content, the content being audio, video, graphics, text etc. It would also be desirable to provide a flexible and hierarchical linking structure. This would allow some parts of the metadata to be valid for large parts of the content, while other parts may be valid for shorter periods during those large parts, i.e. enabling overlapping validity. Also, individual parts of the metadata or metadata items may be valid multiple times, or have overlapping points for starting or stopping validity.

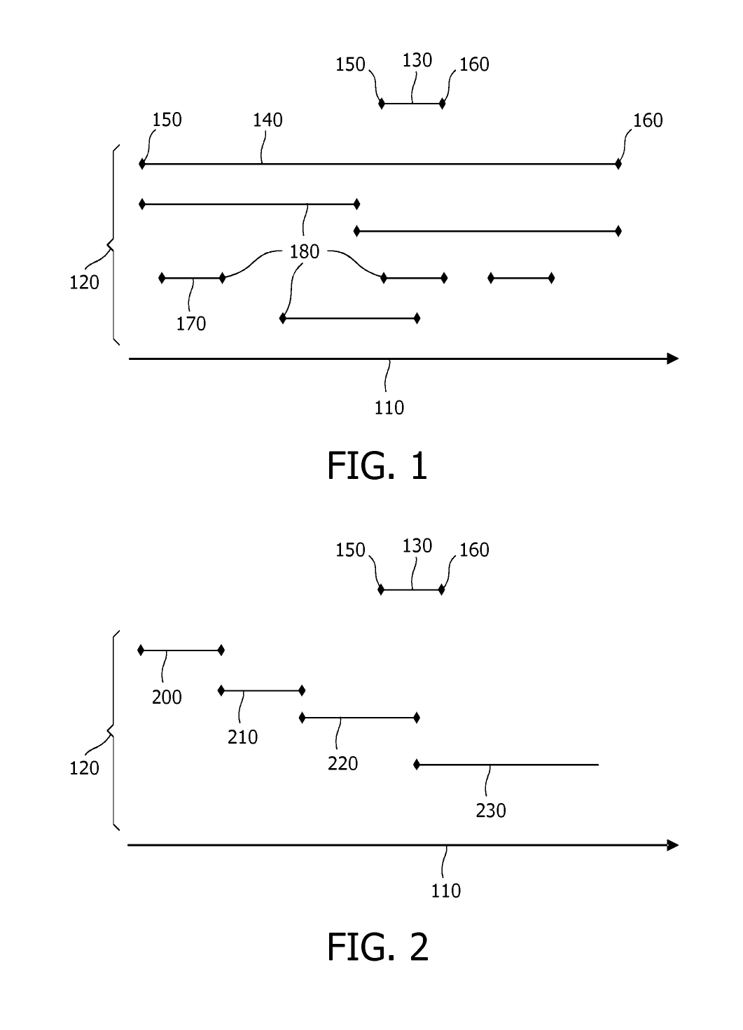

An example of such a complex situation is illustrated in FIG. 1. In FIG. 1 a media timeline 110 is indicated. This may be defined in time, position in a broadcast stream, byte position in a file etc. Also shown in FIG. 1 are at least one metadata item 140, a further metadata item 170, and a plurality of metadata items 180. The plurality may or may not include the at least one metadata item 140 and the further metadata item 170. The period of validity of metadata items 130 is indicated in FIG. 1. There is an indication of a point where a metadata item becomes valid 150 and an indication of a point where a metadata item becomes invalid 160. The at least one metadata item 140, the further metadata item 170, and/or the plurality of metadata items 180 may also be combined into a single item, termed metadata 120, and processed in such a manner.

Using a timed metadata track, the start of the valid region for the metadata is signaled by the presentation time of the sample. However, no trivial solution to determine the period of validity is available. Such a situation is illustrated in FIG. 2 where use is made of a single track timed metadata. Metadata items may only be defined in a sequential manner. For example, as a first sequential metadata item 200, a second sequential metadata item 210, a third sequential metadata item 220 and a fourth sequential metadata item 230. There can be no overlap between the sequential metadata items and there is no explicit validity. In other words a metadata item remains valid until the next metadata sample arrives such that the latest sample remains valid. As can be seen there is no hierarchy possible.

Furthermore, currently only MetaDataSampleEntries exist for XML and plain text. Metadata containers and other possible data, such as initialization data, cannot yet be stored yet. Related to this, it is only possible to reference metadata stored in samples of the timed metadata track. It is possible to reference other parts of the file, because generally that is what happens when referencing samples. Generally, samples are stored in “mdat” boxes, but they could be stored anywhere in the file if that information is allowed at that place. Therefore, metadata in a “meta” box can be referenced as a sample. However, this is not very convenient as it has to be done bytewise with offset and length, which is not a very common way to refer to XML elements. It is also error-prone. Therefore, it is not possible to store references to metadata defined elsewhere in a flexible way. In other words it is not possible to store references to metadata defined outside of the timed metadata track. It is neither possible to store hierarchical constructions. Therefore, there is no mechanism using timed metadata to store a hierarchy indicating metadata valid for the whole file and metadata valid only for specific content elements or metadata whose validity overlaps. The only option is to provide multiple timed metadata tracks.

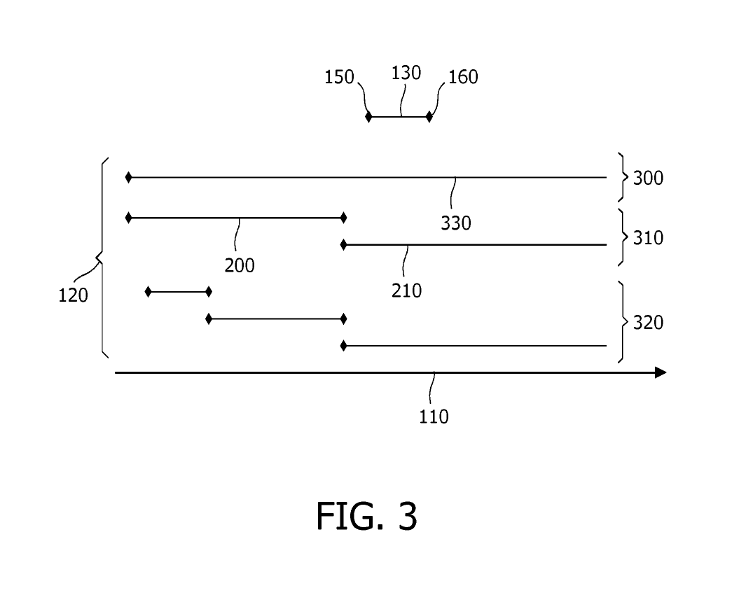

FIG. 3 illustrates the use of multiple timed metadata tracks. A first timed metadata track 300 comprises a single metadata item 330. A second metadata track 310 comprises the first sequential metadata item 200 and the second sequential metadata item 210. As was the case for the situation shown in FIG. 2 there can be no overlap between the sequential metadata items, within a single timed metadata track, and there is no explicit validity. In other words a metadata item remains valid, within a single timed metadata track, until the next metadata sample arrives such that the latest sample remains valid. As can be seen there is no hierarchy possible.

The use of multiple timed metadata tracks is undesirable since it forms a complex file structure and it requires extra processing to merge the multiple timed metadata tracks when an overview of all metadata relevant to the complete file is required. This extra overhead which is introduced is especially problematic for devices with limited processing power, such as mobile telephones and the like. Synchronized Auxiliary Data as defined in ETSI TS 102 823 standard Version 1.1.1 dated 2005-11 may be considered, but generating such data is quite complex. This is because Synchronized Auxiliary Data is broadcast oriented and is based upon the synchronization between a broadcast timeline and a metadata timeline. A broadcast timeline is not needed for the storage of metadata in a file and therefore such a solution again is unnecessarily complicated.

To efficiently store and retrieve all metadata of a specific DVB file it should preferably be stored in one single place. The ISO Base File Format has some provisioning for this in the “meta” box. This “meta” box is designed to store static metadata that is valid for a file, a movie or a track. The relation to a file, a movie or a track depends upon the location of the box. If certain metadata is valid for only a part of the content in the file, it is also of importance for the whole file. When an overview of everything in the file is requested, then all metadata related to the file should be provided. Hence, in the scope of the present application it is preferable to store all metadata in this single box for efficient retrieval. In such a way the file format provides an efficient manner of storing and retrieving all metadata of a specific DVB file.

Parts of the metadata may be identified by Uniform Resource Indicators (URIs) or another suitable indicator or identifier. Most, if not all, current DVB metadata schemas already provide a mechanism to reference specific parts of a metadata collection with a URI. If a metadata schema does not have such provisioning, a URI may easily be linked to a metadata fragment within the scope of the file containing the metadata. This mechanism is already available in the ISO Base File Format.

To associate certain parts of the metadata with certain parts of the content a timed metadata track can be used as described in ISO/IEC 14496-12:2005/Amd 1:2007. Another mechanism under consideration provides the ability to reference to a URI from a timed metadata sample. Combining the storage of all metadata in the “meta” box with the URI referencing mechanism leads to efficient retrieval of all metadata. However, only the start of the validity of parts of the metadata can be indicated. There are at least two problems that still need to be overcome. Namely, it is not possible to indicate multiple metadata elements that have overlapping validity or become valid at the same time neither is it possible to indicate the duration of the validity of a metadata element.

The introduction of a new timed metadata sample can overcome both problems by containing both a list of URIs and an indication for every URI if it is valid from this point on or, alternatively, it is not valid anymore from this point on. In this way, a complex, multi-layered validity structure can be conveyed in the timed metadata track and a player, or receiver, knows exactly what is valid at a certain point in time when playing the file.

To facilitate rendering of the correct metadata during trick play modes, additionally once every content item or every couple of seconds or minutes etc, a complete list of URIs of the currently valid metadata may be given. Such a metadata sample may be marked as a sync sample. Such a concept has been used in relation to video encoding where I-frames provide suitable trick play synchronization points. Suitable well-known mechanisms may then be used to retrieve the set of valid metadata during trick play. For example, for a specific point in time or to find the nearest earlier sync sample and render the track from that point on.

Accordingly, the present application discloses the introduction of a timed metadata sample that validates and invalidates parts of the metadata and acts like a difference describing language, while keeping the metadata in one place for easy, and efficient, access.

In one embodiment use can made be of the ISO Base File Format. This allows easy incorporation into many consumer devices compatible with the DVB file format. A sample entry may be defined that may be referenced from a timed metadata track to indicate the type of metadata sample, along with the sample format:

class URIDiffSampleEntry( ) extends MetaDataSampleEntry(‘udmd’) {
}
aligned(8) class URIDiffSample( ) {

unsigned int(16) entry_count;
for (i=0; i<entry_count; i++) {

bit(8) flags; // now only used for on-off
URIBox uri;

}

}

The “flags” entry enable an indication of the validity or invalidity per metadata item.

Alternatively, instead of adding a flag per metadata item, the sample can be split up in a valid and invalid list:

aligned(8) class URIDiffSample( ) {

unsigned int(16) valid_entry_count;
for (i=0; i<valid_entry_count; i++) {

URIBox uri;

}
unsigned int(16) invalid_entry_count;
for (i=0; i<invalid_entry_count; i++) {

URIBox uri;

}

}

Alternatively, when the URIs are not capable of clearly indicating what type of metadata it points to, the URIs may be grouped by type explicitly. The sample then might look as follows:

aligned(8) URIDiffSample( ) {

unsigned int(8) type_count;
for (i=0; i<type_count; i++) {

int(32) handler; // 4CC of metadata items
unsigned int(16) entry_count;
for (j=0; j<entry_count; j++) {

bit(8) flags;
URIBox uri;

}

}

}

The grouping by type permits a more efficient encoding of the “flags” entry. It should be understood that if a group of metadata items become valid at the same time they do not necessarily need to also become invalid at the same time. As an example, if metadata item 1, metadata item 2 and metadata item 3 all become valid at time “A”, metadata items 1 and 2 may become invalid at time “B” whereas metadata item 3 may become invalid at time “C”. In other words, the group of valid metadata items does not have to have a corresponding group of invalidated metadata items.

Alternatively, instead of using URIs, the combination of a metadata handler and an “Item ID” may be used to point to a specific item in a metadata box. Note that use of the metadata handler and the “Item ID” parameter implies that only separate items can be referenced, while when using URIs, or another generic identifier, or resolvable identifier, also parts of items can be referenced. This is true only if the identifier or URI scheme for the specific metadata format allows it. The embodiment may therefore be described by:

class ItemDiffSampleEntry( ) extends MetaDataSampleEntry(‘idmd’) {
}
aligned(8) ItemDiffSample( ) {

unsigned int(8) type_count;
for (i=0; i<type_count; i++) {

int(32) handler; // 4CC of metadata items
unsigned int(16) entry_count;
for (j=0; j<entry_count; j++) {

bit(8) flags;
unsigned int(16) item_ID;

}

}

}

Furthermore, using a technique described in proposal N9307 under consideration for amendment into ISO/IEC 14496-12 metadata items may be built as an aggregation of a number of other metadata items. If a group of metadata items is always switched on or off together, such an aggregation can be defined to make the sample entries smaller in size and therefore more efficient.

### Hierarchy Support

In some cases, a number of metadata items may conflict in the sense that they might assign a different value to the same parameter if more than one of those items is marked as valid during a specific interval. If no hierarchy is defined, it may be assumed that the parameters take all the values of the currently valid metadata items, however that may not be the correct behavior. A hierarchy may be defined to aid in this conflict resolution, either implicitly or explicitly.

An implicit hierarchy may be defined in such a way that the shortest spanning item, for example in duration, takes preference. In other words in FIG. 1, the top level, more globally valid metadata items may be overridden for short periods by locally valid metadata items. Alternatively, the item that is marked valid as last may take preference over other items. Other alternatives may also be introduced.

The hierarchy may also be defined explicitly by adding a field indicating the importance of an item to the sample:

aligned(8) URIDiffSample( ) {

unsigned int(16) entry_count;
for (i=0; i<entry_count; i++) {

bit(8) flags; // now only used for on-off
int(8) z-index; // for indicating hierarchy
URIBox uri;

}

Alternatively, if fewer granularities are required, a number of the unused bits in the “flags” field may be used.

An added advantage of using URIs instead of referencing directly to metadata in the file is that a caching mechanism is easier to implement. This is because a metadata fragment is uniquely identified by the URI, or other suitable identifier. However, when a certain direct reference is used it is not always known if a certain direct reference is the same or different from another reference without having to parse the references. For example, individual XML fragments are often identified explicitly rather than by byte offsets. In practice this would require full parsing, by an XML parser, either at transmission time or reception time depending upon at which point in time the metadata is to be encoded into a file format compatible with or based upon the ISO Base File Format. When performed in the receiver this is a problem for many devices with limited processing power, such as mobile phones or other portable devices.

### Synchronization Support

A list of all valid metadata items may be provided at regular intervals. Such a list implicitly invalidates all previous items and thus gives a complete list of the currently valid items. The effect of this is that the list acts as a synchronization sample. Such a synchronization sample is extremely beneficial for trick play modes.

This is because no information prior to this metadata sample is needed to render the correct items. The fact that a metadata sample is a synchronization sample may be indicated in the ISO Base File Format in the sync sample table. Such use is described in ISO/IEC 14496-12 Annex A.7 entitled “Random access”. Alternatively, one of the unused flags in the proposed boxes can be used to indicate this. Another flag which is valid for the complete sample rather than for every item may also be introduced.

When embodiments of the invention are implemented based on the ISO Base File Format they may be incorporated in the DVB file format standard. Hence, the embodiments become applicable for all digital video reception devices with storage capability. The embodiments are also applicable to all devices storing media content with synchronized metadata.

Within the present application reference is made to the ISO Base Media File format. Such as reference is to be interpreted as also including a file format compatible with or based on the ISO Base Media File format. Furthermore, where a reference is made to a “URI” it is to be understood that this may also encompass suitable equivalents to a URI having the same effect as identifying or being suitable resolvable to identify a particular item. All embodiments disclosed herein work equally well with other means of indicating a fragment or element of metadata.

Within the present application reference is also made to a “box” or “boxes” when discussing a box in relation to the file format. Such terminology is defined and used within ISO/IEC 14496-12. A “box” generally relates to an object-oriented building block defined by a unique type identifier and length. A “sample”, again in the terminology as is defined and used within ISO/IEC 14496-12, relates to formation of one or more streaming packets with time stamps and such “samples” used in the transmission of continuous media. The validity information of the metadata items can be regarded as continuous media information. Boxes are normally not transmitted in samples, unless the file is wrapped in some other encapsulation format. Samples are contained in boxes, normally the “mdat” box and referred to from other boxes. Metadata and metadata items may therefore be encoded or embodied as “boxes” or encoded or embodied in “samples” and yet still provide the advantages of the present invention.

Throughout this text the term “single box or a single sample” is used in relation to the validity information that is encoded in samples of a timed metadata track. It is to be understood that for each point in time where the validity of any item changes, a new sample is created with the required updates for validity at that point in that single sample. Therefore, not all validity information is thus in a single sample. However, this does not preclude an embodiment wherein all validity information could be in a single box or sample.

The invention may also be embodied in various forms. For example, an embodiment may be a transmitter, or transmitting device, for transmitting metadata and media data. The transmitter will often transmit at least the media, even though the media data is, in fact, irrelevant for embodiments of the present invention. The transmitter may also transmit the metadata. The transmitter may also explicitly state when the metadata will be valid and when it will be invalid, or this may done implicitly. In an example, if metadata is transmitted during a first show it will be valid during the first show and the metadata transmitted during a second show will be valid during the second show but not during the first show. The validity of the metadata may be encoded in the metadata itself or stated separately. The metadata or validity information or both may also be gathered over a different channel. This different channel may, for example, be the Internet.

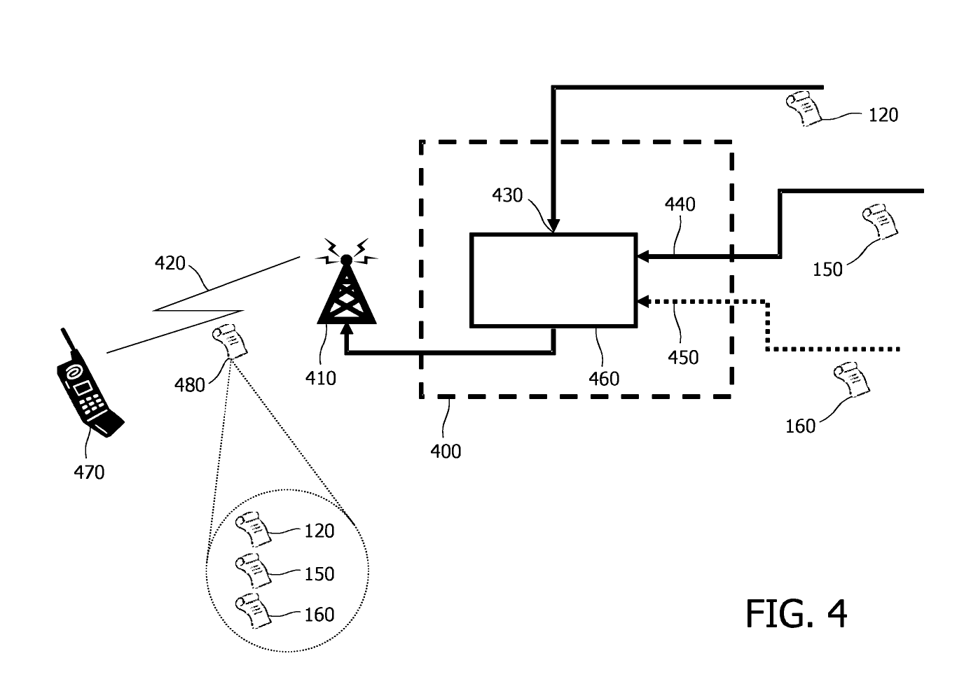

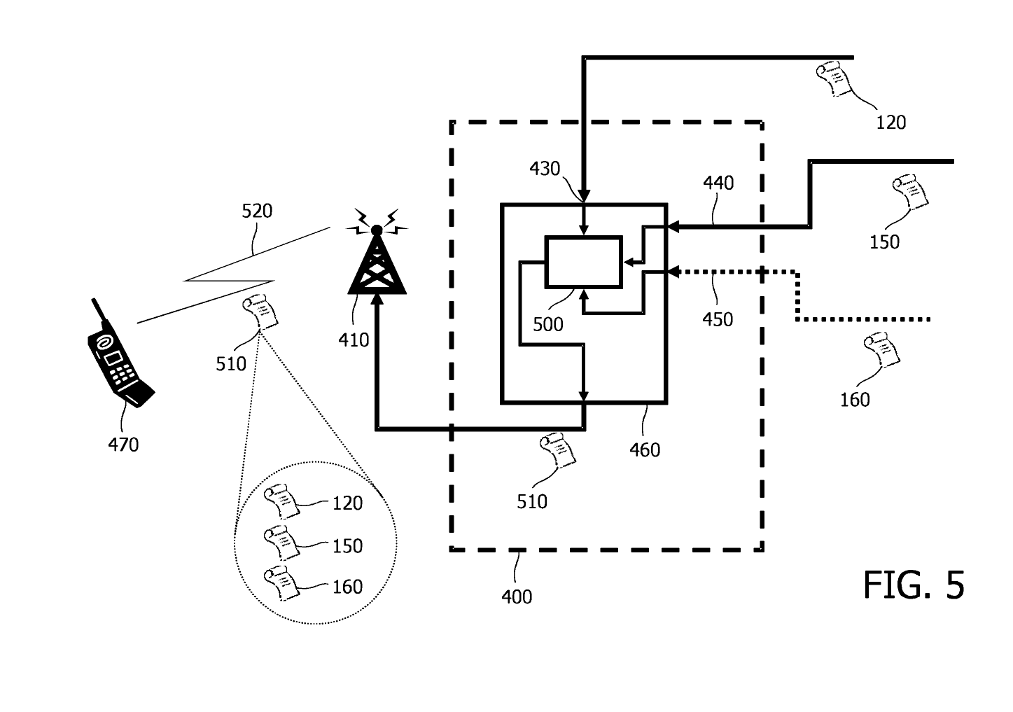

An embodiment of a transmitter 400 is shown in FIG. 4. The transmitter 400 may comprise a transmitting unit 460. Metadata 120 may be received by the transmitting unit 460 on a first input 430. The indication of a point at which the metadata 120 becomes valid 150 may be received by the transmitting unit 460 on a second input 440. The indication of a point at which the metadata 120 becomes invalid 160 may be received by the transmitting unit 460 on a third input 450. The information may be transmitted to a receiver 470 in a form suitable for encoding in a file format compatible with or based upon an ISO Base File Format 480. Such transmission may take place by transmitting a suitable signal, signal 420, from an antenna 410.

A further embodiment of a transmitter 400 is shown in FIG. 5. The transmitting unit 460 may comprise an encoder 500. Metadata 120 may be received by the encoder 500 from the first input 430. The indication of a point at which the metadata 120 becomes valid 150 may be received by the encoder 500 from the second input 440. The indication of a point at which the metadata 120 becomes invalid 160 may be received by the encoder 500 from the third input 450. The information may then be encoded in a file format compatible with or based upon an ISO Base File Format 510 by the encoder 500. The file format compatible with or based upon an ISO Base File Format 510 may then be transmitted by transmitting a suitable signal, signal 520, from the antenna 410. The signal 520 may be a signal containing a file format compatible with or based upon an ISO Base File Format.

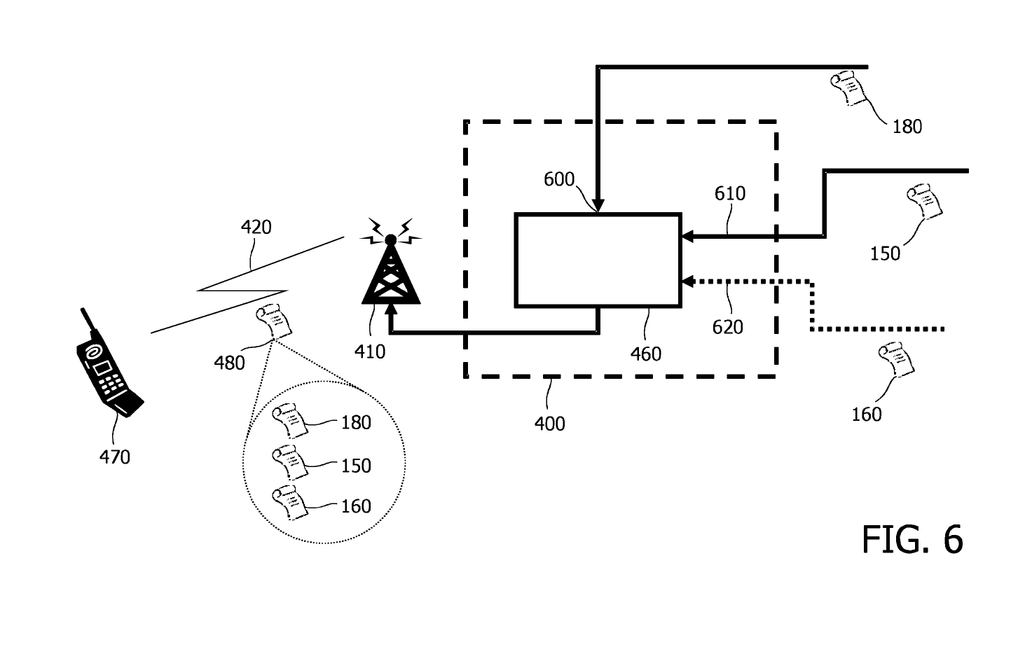

Another embodiment shown in FIG. 6 illustrates the transmission of the plurality of metadata items 180. The plurality of metadata items 180 is received on a fourth input 600. On a fifth input 610 the indication of a point at which a metadata item becomes valid 150 is received. On a sixth input 620 the indication of a point at which a metadata item becomes invalid 160 is received. The information is collated and transmitted via antenna 410 to a receiver 470.

In an embodiment wherein a transmitter only transmits metadata and explicit or implicit validity information a receiver, or recording device, may encode the metadata and explicit or implicit validity information and generate and store a file in the file format compatible or based upon the ISO Base File Format. The receiver may record the metadata in a file as transmitted, or it may record only parts of the metadata transmitted. The receiver may also add the validity information itself if it is not contained within the broadcast.

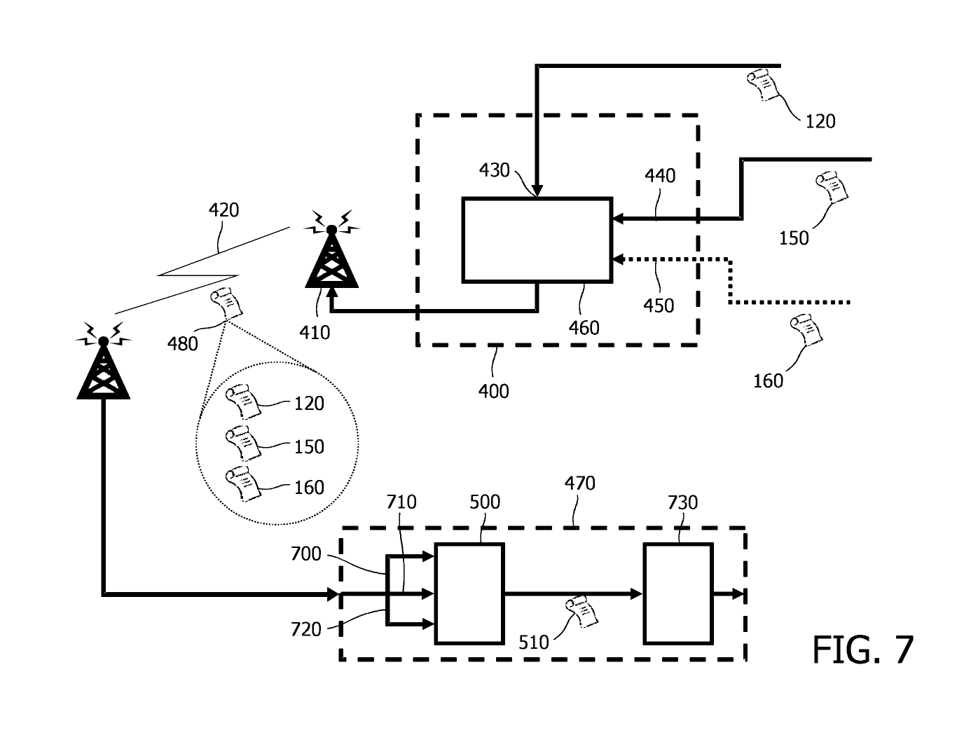

The embodiment shown in FIG. 7 shows such an embodiment. The receiver 470 may comprise the encoder 500 for encoding the metadata 120, the indication of a point at which the metadata 120 becomes valid 150 and the indication of a point at which the metadata 120 becomes invalid 160. All of which may be received from the transmitter 400. The encoder 500 may encode the information in the file format compatible with or based upon an ISO Base File Format 510. The file format compatible with or based upon an ISO Base File Format 510 may then, or at any subsequent point in time, be decoded by a decoder 730.

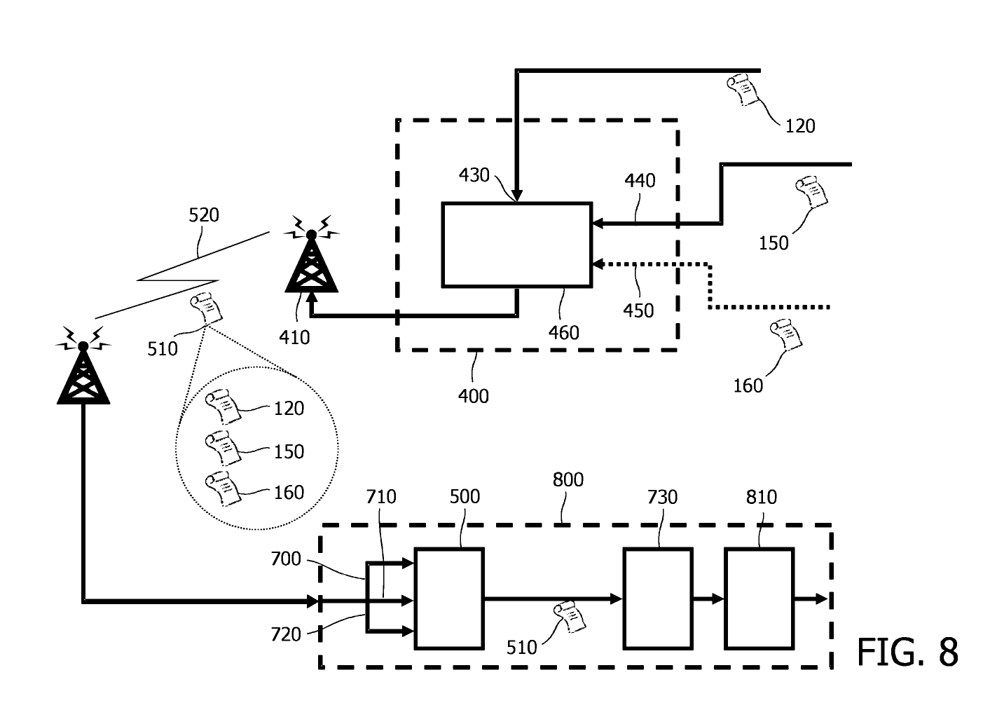

In an embodiment, as shown in FIG. 8, of a corresponding and co-operating rendering device 800, or playback device, such a rendering device may show all metadata to give a good overview of the contents of the file merely by accessing the file stored in the file format compatible or based upon the ISO Base File Format. A rendering unit 810 capable of rendering the metadata 120 decoded by the decoder 730 may be displayed to a user via any suitable display (not shown). All information is then contained in a single place leading to an efficient form for retrieval, as well as for storage. The rendering device may display valid metadata while playing the file. Also, the validity information may be used as means of indexing. It becomes possible to jump to a point in the file were a specific metadata item becomes valid.

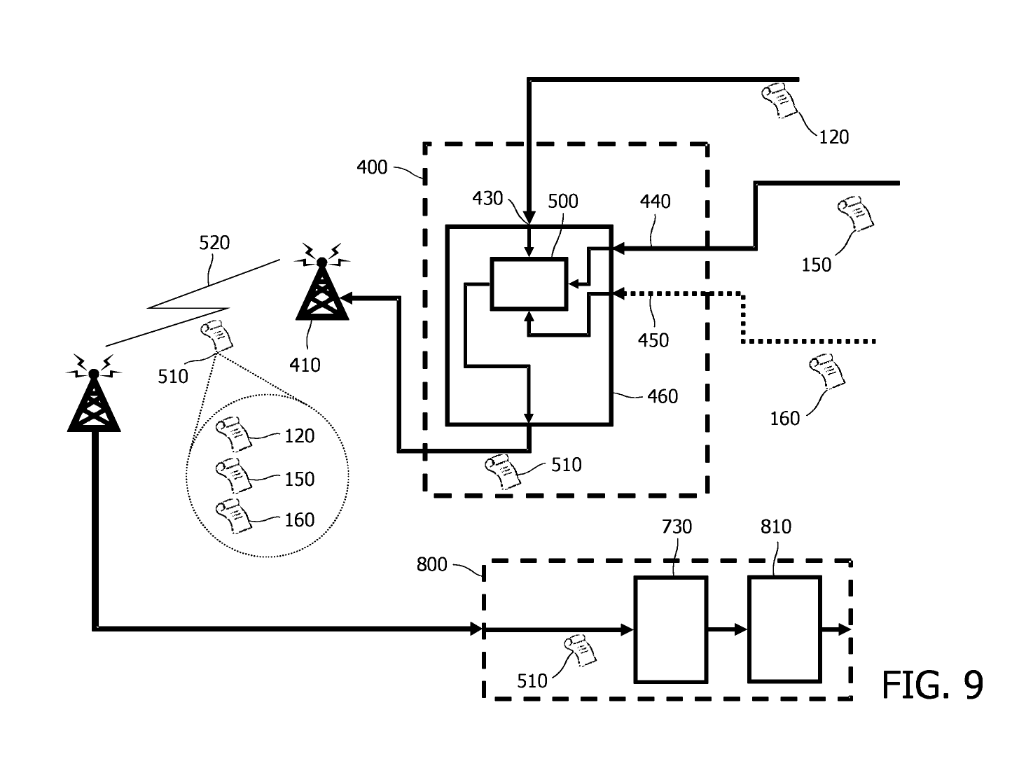

The embodiment of FIG. 9 illustrates a rendering device 800 that may directly receive information in the file format compatible with or based upon an ISO Base File Format 510. The rendering unit 810 renders the metadata 120, or the plurality of metadata items 180 as the case may be, decoded by the decoder 730. This may again be displayed to a user via any suitable display (not shown).

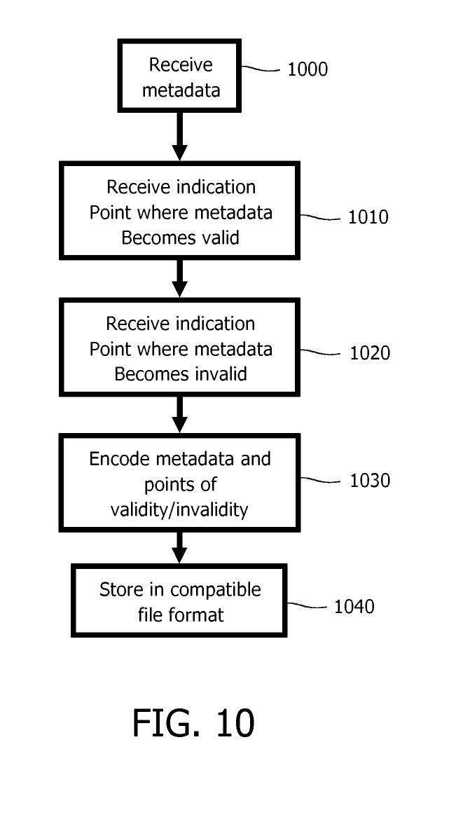

FIG. 10 illustrates a flowchart providing an overview of an embodiment of the invention. At step 1000 metadata 120 is obtained or received. At step 1010 an indication of a point at which the metadata 120 becomes valid 150 is obtained or received. At step 1020 an indication of a second point at which the metadata 120 becomes invalid 160 is obtained or received. At step 1030 the metadata is encoded in the file format compatible with or based upon the ISO Base File Format 510. The indication of a point at which the metadata 120 becomes valid 150 and the indication of a second point at which the metadata 120 becomes invalid 160 is also encoded in the file format compatible with or based upon the ISO Base File Format 510. At step 1040 a file is stored in the file format compatible with or based upon the ISO Base File Format 510.

In summary the present application discloses methods and devices for providing metadata to be stored. The storage may be in a file format compatible with or based upon an ISO Base File Format. The period or regions of validity of metadata is used as input and stored in the file format. The periods may be indicated by a point at which the metadata becomes valid and a second point at which the metadata becomes invalid. The metadata may be encoded, by an encoder, in a file format compatible with or based upon an ISO Base Media File format. Similarly, the indication of the point at which the metadata becomes valid and the indication of the second point at which the metadata becomes invalid may also be encoded in the file format compatible with or based upon the ISO Base Media File format. This may be performed by a transmitter, prior to transmission, or by a receiver after reception. A plurality of metadata items may also be stored in the file format in a single location providing efficient storage and retrieval. A hierarchy related to each individual metadata item may also be attached allowing complex metadata structures to be stored. A list of all valid individual metadata items may be provided in a regular manner. This may be used as a synchronization point and is especially useful in trick play modes.

It should be noted that the above-mentioned embodiments illustrate rather than limit the invention, and that those skilled in the art will be capable of designing many alternative embodiments without departing from the scope of the invention as defined by the appended claims. Furthermore, any of the embodiments described comprise implicit features, such as, an internal current supply, for example, a battery or an accumulator. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A method for providing metadata to be stored, the method comprising:
obtaining the metadata;
obtaining an indication of a point at which the metadata becomes valid;
obtaining an indication of a second point at which the metadata becomes invalid;
encoding the metadata obtained in a file format compatible with or based upon an ISO Base Media File format;
encoding the indication of the point at which the metadata becomes valid in the file format compatible with or based upon the ISO Base Media File format; and
encoding the indication of the second point at which the metadata becomes invalid in the file format compatible with or based upon the ISO Base Media File format.

2. The method of claim 1, comprising:
obtaining the metadata as a plurality of metadata items;
obtaining for each metadata item an indication of a third point at which each metadata item becomes valid;
obtaining for each metadata item an indication of a fourth point at which each metadata becomes invalid;
encoding the indication of the third point and the indication of the fourth point in a single box or a single sample in the file format compatible with or based upon the ISO Base Media File format.

3. The method of claim 2, comprising:
obtaining for at least one metadata item of the plurality of metadata items an identifier capable of identifying or being resolved to identify the at least one metadata item;
encoding the identifier in the single box or the single sample in the file format compatible with or based upon the ISO Base Media File format.

4. The method of claim 3, wherein the identifier is a Uniform Resource Indicator.

5. The method of claim 3, comprising:
obtaining for at least two metadata items of the plurality of metadata items an indication of a type of the at least two metadata items;
forming a group of metadata items according to the indication of the type of the at least two metadata items; and
encoding in a grouped manner each identifier of the group of metadata items in the single box or the single sample in the file format compatible with or based upon the ISO Base Media File format; and
encoding in the grouped manner the indication of the third point and/or the indication of the fourth point.

6. The method of claim 2, comprising:
obtaining for at least one metadata item of the plurality of metadata items an item identifier;
encoding the item identifier for at least one metadata item in the single box or the single sample in the file format compatible with or based upon the ISO Base Media File format.

7. The method of claim 2, comprising:
obtaining for at least one metadata item of the plurality of metadata items a hierarchy indication;
encoding the hierarchy indication for the at least one metadata item in the single box or the single sample in the file format compatible with or based upon the ISO Base Media File format.

8. The method of claim 2, comprising:
forming for a fifth point a list of all valid metadata items based upon the indication of the third point at which the metadata items become valid and the indication of a fourth point at which the metadata items become invalid;
encoding the list in the single box or the single sample in the file format compatible with or based upon the ISO Base Media File format.

9. The method of claim 8, comprising:
forming the list in a repeatable manner for a plurality of points;
encoding the list in the file format compatible with or based upon the ISO Base Media File format in a repeatable manner to provide a plurality of synchronization points from which the validity of each metadata item may be inferred.

10. A transmitter for transmitting metadata to be stored, the transmitter comprising:
a first input for obtaining the metadata;
a second input for obtaining an indication of a point at which the metadata becomes valid;
a third input for obtaining an indication of a second point at which the metadata becomes invalid; and
a transmitting unit, communicatively coupled to the first input, the second input and the third input, for transmitting the metadata, the indication of the point at which the metadata becomes valid, and the indication of the second point at which the metadata becomes invalid, the transmission being in a form suitable for encoding in a file format compatible with or based upon an ISO Base Media File format.

11. The transmitter of claim 10 wherein the transmitting unit comprises:
an encoder, communicatively coupled to the first input, the second input and the third input, and
for encoding the metadata obtained in the file format compatible with or based upon the ISO Base Media File format;
for encoding the indication of the point at which the metadata becomes valid in the file format compatible with or based upon the ISO Base Media File format; and
for encoding the indication of the second point at which the metadata becomes invalid in the file format compatible with or based upon the ISO Base Media File format; and wherein
the transmitting unit being configured for transmitting the file format compatible with or based upon the ISO Base Media File format.

12. The transmitter of claim 11, comprising:
a fourth input for obtaining the metadata as a plurality of metadata items;
a fifth input for obtaining for each metadata item an indication of a third point at which each metadata item becomes valid;
a sixth input for obtaining for each metadata item an indication of a fourth point at which each metadata becomes invalid;
the encoder being communicatively coupled to the fourth input, the fifth input and the sixth input, and
for encoding the indication of the third point and the indication of the fourth point in a single box or a single sample in the file format compatible with or based upon the ISO Base Media File format.

13. A method of transmitting metadata to be stored, the method comprising:
obtaining the metadata;
obtaining an indication of a point at which the metadata becomes valid;
obtaining an indication of a second point at which the metadata becomes invalid; and
transmitting the metadata, the indication of the point at which the metadata becomes valid, and the indication of the second point at which the metadata becomes invalid in a form suitable for encoding in a file format compatible with or based upon an ISO Base Media File format.

14. The method of claim 13, comprising:
encoding the metadata obtained in the file format compatible with or based upon the ISO Base Media File format;
encoding the indication of the point at which the metadata becomes valid in the file format compatible with or based upon the ISO Base Media File format;
encoding the indication of the second point at which the metadata becomes invalid in the file format compatible with or based upon the ISO Base Media File format; and
transmitting the file format compatible with or based upon the ISO Base Media File format.

15. A receiver for receiving metadata to be stored, the receiver comprising:
a first input for receiving the metadata;
a second input for receiving an indication of a point at which the metadata becomes valid;
a third input for receiving an indication of a second point at which the metadata becomes invalid;
an encoder, communicatively coupled to the first input, the second input and the third input, and
for encoding the metadata obtained in a file format compatible with or based upon an ISO Base Media File format;
for encoding the indication of the point at which the metadata becomes valid in the file format compatible with or based upon the ISO Base Media File format; and
for encoding the indication of the second point at which the metadata becomes invalid in the file format compatible with or based upon the ISO Base Media File format.

16. The receiver of claim 15, comprising:
a fourth input for receiving the metadata as a plurality of metadata items;
a fifth input for receiving for each metadata item an indication of a third point at which each metadata item becomes valid;
a sixth input for receiving for each metadata item an indication of a fourth point at which each metadata becomes invalid;
the encoder being communicatively coupled to the fourth input, the fifth input and the sixth input, and
for encoding the indication of the third point and the indication of the fourth point in a single box or a single sample in the file format compatible with or based upon the ISO Base Media File format.

17. The receiver of claim 15, comprising:
a decoder for decoding the metadata encoded in the file format compatible with or based upon the ISO Base Media File format;
for decoding the indication of the point at which the metadata becomes valid in the file format compatible with or based upon the ISO Base Media File format; and
for decoding the indication of the second point at which the metadata becomes invalid in the file format compatible with or based upon the ISO Base Media File format.

18. The receiver of claim 15 realized as at least one of the group consisting of:
a Set-Top-Box device;
a digital video recording device;
a network-enabled device;
a conditional access system;
a portable audio player;
a portable video player;
a mobile phone;
a DVD player;
a CD player;
a hard disk based media player;
an Internet radio device;
a computer;
a television;
a public entertainment device; and
an MP3 player.

19. A method of receiving metadata to be stored, the method comprising:
receiving the metadata;
receiving an indication of a point at which the metadata becomes valid;
receiving an indication of a second point at which the metadata becomes invalid;
encoding the metadata obtained in a file format compatible with or based upon an ISO Base Media File format;
encoding the indication of the point at which the metadata becomes valid in the file format compatible with or based upon the ISO Base Media File format; and
encoding the indication of the second point at which the metadata becomes invalid in the file format compatible with or based upon the ISO Base Media File format.

20. A method of rendering metadata provided in the file format compatible with or based upon the ISO Base Media File format of claim 14, the method comprising:
decoding the metadata encoded in the file format compatible with or based upon the ISO Base Media File format;
decoding the indication of the point at which the metadata becomes valid in the file format compatible with or based upon the ISO Base Media File format; and
decoding the indication of the second point at which the metadata becomes invalid in the file format compatible with or based upon the ISO Base Media File format; and
rendering the metadata in accordance with the indication of the point at which the metadata becomes valid and the indication of the second point at which the metadata becomes invalid.

21. A rendering device for rendering the file format compatible with or based upon the ISO Base Media File format of claim 14, the rendering device comprising:
a decoder for decoding the metadata encoded in the file format compatible with or based upon the ISO Base Media File format;
for decoding the indication of the point at which the metadata becomes valid in the file format compatible with or based upon the ISO Base Media File format; and
for decoding the indication of the second point at which the metadata becomes invalid in the file format compatible with or based upon the ISO Base Media File format; and
a rendering unit for rendering the metadata in accordance with the indication of the point at which the metadata becomes valid and the indication of the second point at which the metadata becomes invalid.

22. A signal 420 for use in providing metadata to be stored, the signal comprising:
the metadata;
an indication of a point at which the metadata becomes valid;
an indication of a second point at which the metadata becomes invalid;
the signal being suitable for
encoding the metadata in a file format compatible with or based upon an ISO Base Media File format;
encoding the indication of the point at which the metadata becomes valid in the file format compatible with or based upon the ISO Base Media File format; and
encoding the indication of the second point at which the metadata becomes invalid in the file format compatible with or based upon the ISO Base Media File format.

23. A signal 520 for use in providing metadata to be stored, the signal comprising:
the metadata encoded in a file format compatible with or based upon an ISO Base Media File format form;
an indication of a point at which the metadata becomes valid encoded in the file format compatible with or based upon the ISO Base Media File format form; and
an indication of a second point at which the metadata becomes invalid encoded in the file format compatible with or based upon the ISO Base Media File format form.

24. A system for providing metadata to be stored, the system comprising:
the transmitter according to claim 10;
the signal 420 for use in providing metadata to be stored, the signal comprising:
the metadata;
an indication of a point at which the metadata becomes valid;
an indication of a second point at which the metadata becomes invalid;
the signal being suitable for
encoding the metadata in a file for a compatible with or based upon an ISO Base Media File format;
encoding the indication of the point at which the metadata becomes valid in the file format compatible with or based upon the ISO Base Media File format; and
encoding the indication of the second point at which the metadata becomes invalid in the file format compatible with or based upon the ISO Base Media File format; and
the receiver for receiving metadata to be stored, the receiver comprising:
a first input for receiving the metadata;
a second input for receiving an indication of a point at which the metadata becomes valid;
a third input for receiving an indication of a second point at which the metadata becomes invalid;
an encoder, communicatively coupled to the first input, the second input and the third input, and
for encoding the metadata obtained in a file format compatible with or based upon an ISO Base Media File format;
for encoding the indication of the point at which the metadata becomes valid in the file format compatible with or based upon the ISO Base Media File format; and
for encoding the indication of the second point at which the metadata becomes invalid in the file format compatible with or based upon the ISO Base Media File format.

25. A system for providing metadata to be stored, the system comprising:
the transmitter for transmitting metadata to be stored, the transmitter comprising:
a first input for obtaining the metadata;
a second input for obtaining an indication of a point at which the metadata becomes valid;
a third input for obtaining a indication of a second point at which the metadata becomes invalid; and
a transmitting unit, communicatively coupled to the first input, the second input and the third input, for transmitting the metadata, the indication of the point at which the metadata becomes valid, and the indication of the second point at which the metadata becomes invalid, the transmission being in a form suitable for encoding in a file format compatible with or based upon an ISO Base Media File format wherein the transmitting unit comprises:
an encoder, communicatively coupled to the first input, the second input and the third input, and
for encoding the metadata obtained in the file format compatible with or based upon the ISO Base Media File format;
for encoding the indication of the point at which the metadata becomes valid in the file format compatible with or based upon the ISO Base Media File format; and
for encoding the indication of the second point at which the metadata becomes invalid in the file format compatible with or based upon the ISO Base Media File format; and wherein
the transmitting unit being configured for transmitting the file format compatible with or based upon the ISO Base Media File format;
the signal 520 for use in providing metadata to be stored, the signal comprising:
the metadata encoded in a file format compatible with or based upon an ISO Base Media File format form;
a indication of a point at which the metadata becomes valid encoded in the file format compatible with or based upon the ISO Base Media File format form; and
an indication of a second point at which the metadata becomes invalid encoded in the file format compatible with or based upon the ISO Base Media File format form; and
the rendering device according to claim 21.

26. A program element directly loadable into the memory of a programmable device, comprising software code portions for performing, when said program element is run on the device, the method of:
obtaining metadata;
obtaining an indication of a point at which the metadata becomes valid;
obtaining an indication of a second point at which the metadata becomes invalid;
encoding the metadata obtained in a file format compatible with or based upon an ISO Base Media File format;
encoding the indication of the point at which the metadata becomes valid in the file format compatible with or based upon the ISO Base Media File format; and
encoding the indication of the second point at which the metadata becomes invalid in the file format compatible with or based upon the ISO Base Media File format.

27. A computer-readable medium directly loadable into the memory of a programmable device, comprising software code portions for performing, when said code portions are run on the device, the method of:
obtaining metadata;
obtaining an indication of a point at which the metadata becomes valid;
obtaining an indication of a second point at which the metadata becomes invalid;
encoding the metadata obtained in a file format compatible with or based upon an ISO Base Media File format;
encoding the indication of the point at which the metadata becomes valid in the file format compatible with or based upon the ISO Base Media File format; and
encoding the indication of the second point at which the metadata becomes invalid in the file format compatible with or based upon the ISO Base Media File format.
